(19) United States
(12) Patent Application Publication
(10) Pub. No.: US 2003/0206137 A1
(43) Pub. Date: Nov. 6, 2003

(54) XM satllite radio antenna

(75) Inventor: Timothy Leonard Hunter, Irvine, CA (US)

Correspondence Address: TIMOTHY L. HUNTER, 41 MORENA, IRVINE, CA, 92612, US

(73) Assignee: Mr. Timothy Leonard Hunter, Irvine, CA

(21) Appl. No.: 10/063,542

(22) Filed: May 2, 2002

(51) Int. Cl. H01Q 1/28

(52) U.S. Cl. 343/705; 343/872

(57) ABSTRACT

This patent application is for Tim Hunter for the sole purpose of attaining a patent for the antenna described in this document.

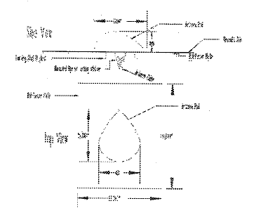

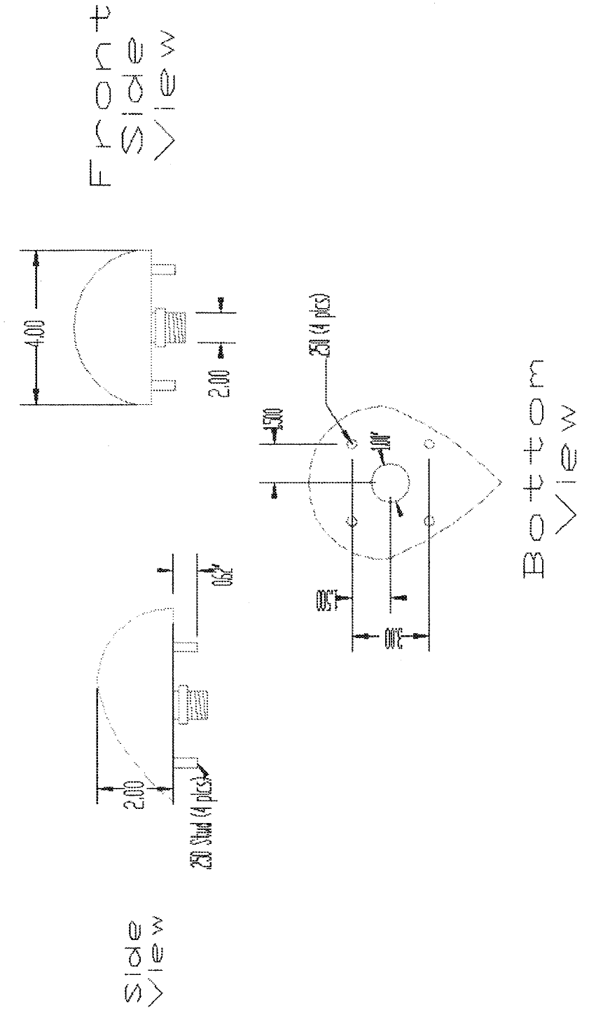

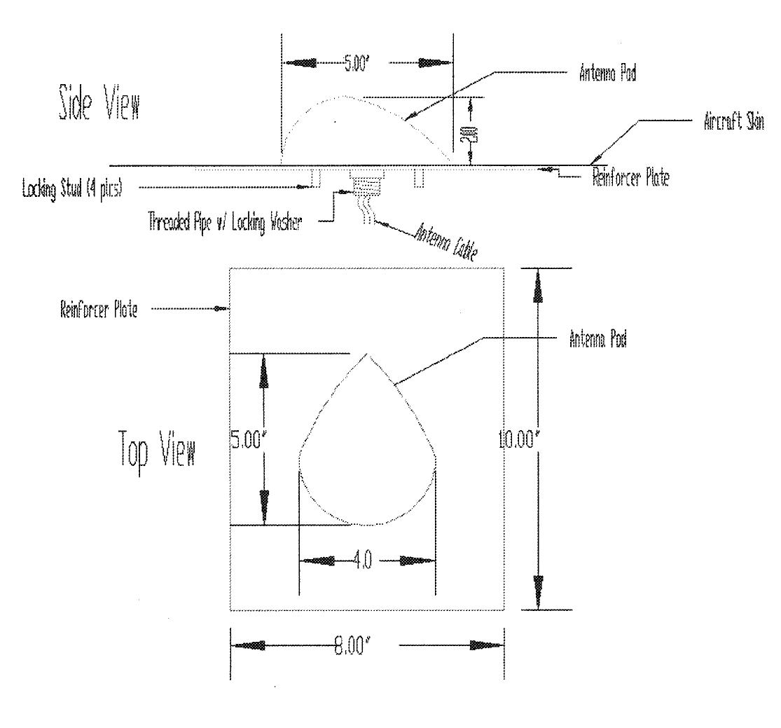

### DETAILED DESCRIPTION

This antenna will be made of a fiberglass shell that covers the antenna element. It will be mounted on the surface of the aircraft with cabling passing through the skin of the aircraft. It will have attaching bolts that pass through the skin of the aircraft to secure the antenna assembly in place. it will use an aircraft approved sealant to seal all holes used for mounting and passing the cabling through the skin of the aircraft

The antenna will receive XM Radio transmissions only on the appropriate frequencies.

1. This antenna will only be able to receive XM Satellite radio Signals.

2. It will not interfere with the normal operation of any aircraft.
